(19) United States
(12) Patent Application Publication
(10) Pub. No.: US 2026/0135146 A1
(43) Pub. Date: May 14, 2026

(54) GRAPHENE SOLID STATE BATTERY

(71) Applicant: Shaune Pierre Bordere, Cypress, TX (US)

(72) Inventor: Shaune Pierre Bordere, Cypress, TX (US)

(21) Appl. No.: 19/443,663

(22) Filed: Jan. 8, 2026

Related U.S. Application Data
(63) Continuation-in-part of application No. 17/693,465, filed on Mar. 14, 2022.
(60) Provisional application No. 63/182,215, filed on Apr. 30, 2021.

(51) Int. Cl. H01M 10/0562; H01M 4/02; H01M 4/131; H01M 4/133; H01M 10/058; H01M 50/128; H01M 50/431; H01M 50/443; H01M 50/46

(52) U.S. Cl. CPC H01M 10/0562; H01M 4/131; H01M 4/133; H01M 10/058; H01M 50/128; H01M 50/431; H01M 50/443; H01M 50/46; H01M 2004/027; H01M 2004/028; H01M 2300/008

(57) ABSTRACT

A solid-state battery includes a solid casing, a solid anode, a solid cathode, and a solid electrolyte. The solid-state battery can include a solid separator disposed between the solid anode and the solid cathode. The solid casing can be a solid layered Graphene casing; the solid anode can be a negatively charged Graphene Oxide metal such as Nickel-Copper; the solid cathode can be a solid positively charged Graphene metal such as Nickel-Copper; the solid electrolyte can be a Fluorinated Graphene (GF_{0.8}) electrolyte. The separator can be a solid Graphene quantum dot separator. Any or all of the components of the solid-state battery can be energy density enhanced.

### CROSS-REFERENCE TO RELATED APPLICATIONS

This application is a continuation-in-part of U.S. patent application Ser. No. 17/693,465, filed on Mar. 14, 2022, which claims the benefit of, and priority to, U.S. Provisional Ser. No. 63/182,215, filed on Apr. 30, 2021, the entire contents of each of which is incorporated herein by reference.

### FIELD

This disclosure relates to solid-state batteries and, more particularly, to Graphene solid-state batteries for use in vehicles, Battery Energy Storage Systems (BESS), and/or other applications.

### BACKGROUND

Current energy storage systems rely on chemical-based designs such as, for example, the Lithium-ion (Li-ion) battery. Li-ion batteries are known to be explosive and flammable because Lithium's melting point (108.5° C.) and boiling point (1,342° C.) are atypically low. The charging speed and storage capacity of Li-ion batteries also pose a challenge due to their low energy density and low power density.

Physicist Michael Faraday, the father of solid-state ionics, discovered that fluorination generates the best electrolyte and solid ionic conductor. He discovered Lead Floride (PbF₂) as one of the first solid-state solid ionic conductor electrolytes in 1834, alongside Silver Sulfide (Ag₂S). In 1980, the Nobel Prize winning solid-state Physicist Dr. John Bannister Goodenough developed what would become the Li-ion battery alongside Koichi Mizushima and Philip John Wiseman, as detailed in European Patent Application Publication No. EP0017400A1. Dr. Goodenough then developed a solid-state battery, alongside Michael Thackeray, as detailed in U.S. Pat. No. 4,507,371. U.S. Pat. No. 8,790,814, and disclosed inorganic nano sheet-enabled Lithium-exchanging surface-mediated cells (SMCs) comprising (a) a cathode comprising a non-Carbon-based inorganic cathode active material having a surface area to capture and store Lithium thereon; (b) an anode comprising an anode current collector alone or both an anode current collector and an anode active material; (c) a porous separator; (d) a Lithium-containing electrolyte in physical contact with the two electrodes, wherein the cathode has a specific surface area no less than 100 m²/g which is in direct physical contact with said electrolyte to receive Lithium ions therefrom or to provide Lithium ions thereto; and (e) a Lithium source. This inorganic SMC provides both high energy density and high-power density not achievable by supercapacitors and Lithium-ion cells.

### SUMMARY

In contrast to Li-ion batteries, there is a one-atom thick layer of Carbon arranged in a hexagonal lattice that is exceptionally strong and highly durable known as Graphene. The boiling point of this Carbon allotrope, Graphene, is 4200° C. and its sublimination occurs at 3652-3697° C., both significantly higher than those of Lithium. A Graphene solid-state battery in accordance with the present disclosure provides these physical properties and addresses the limitations and dangers of Lithium-ion and other Lithium metal batteries. Graphene is a Carbon allotrope that consists of layer(s) of two-dimensional atoms in a hexagonal lattice.

A limited amount of prior art discloses Graphene-based batteries or methods of producing Graphene-based batteries, and even these are not Graphene solid state batteries. One prior art example of a Graphene-based battery consists of a functionalized Graphene cathode, a reduced Graphene Oxide anode, a Li metal counter electrode, a separator, and a 1 M lithium hexafluorophosphate electrolyte in a 1:1 mixture of ethylene carbonate and dimethyl carbonate. This Graphene-based battery has a high-power density due to its fast surface reactions combined with porous morphology and high electrical conductivity and has a high gravimetric energy density as a result of the wide potential energy difference (also known as its voltage) between the Graphene cathode and the Graphene Oxide anode that greatly improves the battery's ability to store greater amounts of energy for longer periods of time.

However, the few prior art Graphene-based batteries, such as the Graphene-based battery noted above, do not provide the benefits of the Graphene solid state battery of this disclosure, as detailed below.

The solid-state Graphene battery of this disclosure may be recyclable, rechargeable, renewable, and sustainable. The battery may comprise a solid-state Graphene structure. The solid-state Graphene battery of this disclosure is capable of an estimated energy density of 2 kilowatt hours per kilogram or more. More specifically, the energy density of the Fluorinated Graphene (GF_{0.8}) electrolyte of the solid-state Graphene battery is estimated to be 2 kilowatt hours per kilogram such that the baseline energy density of the battery may exceed 2 kilowatt hours per kilogram. The Graphene solid-state battery of this disclosure is thus significantly more powerful and durable than current Li-ion batteries. The solid-state Graphene battery of this disclosure has many practical and advanced industrial and commercial applications that vastly improve upon the quality and safety of products currently available in the global market. As a non-limiting example, the solid-state Graphene battery of this disclosure may be utilized in vehicles, e.g., cars, trucks, etc., aircraft, spacecraft, watercraft, electronics, BESS, power generation systems (power plants, generators, etc.), and/or any other suitable applications.

In operation, the solid-state Graphene battery of this disclosure may be used to store energy for long periods of time. The solid-state Graphene battery of this disclosure may also be used, for example, and without limitation, as a power source to generate valuable gas such as Hydrogen and/or Oxygen for fuel cells.

Further, the solid-state Graphene battery of this disclosure does not contain explosive material as with currently available Li-ion batteries.

In aspects of this disclosure, a solid-state Graphene battery is provided including a solid Graphene casing, a solid negatively charged Graphene Oxide metal (e.g., Nickel-Copper) anode, a solid positively charged Graphene metal (e.g., Nickel-Copper) cathode, a solid Fluorinated Graphene (GF_{0.8}) electrolyte, and, in aspects, a solid separator such as, for example, a quantum dot separator (e.g., a Graphene quantum dot separator) positioned at or near a center of the solid Fluorinated Graphene (GF_{0.8}) electrolyte or at any other suitable location between the anode and the cathode.

In aspects, the Graphene casing is a layered solid Graphene casing including at least 100 layers.

In aspects, the solid anode is a nanocomposite anode and/or is energy density enhanced, e.g., by laser induced confined microexplosion from, for example, a solid 100 femtosecond laser.

In aspects, the solid cathode is a nanocomposite cathode and/or is energy density enhanced, e.g., by laser induced confined microexplosion from, for example, a solid 100 femtosecond laser.

In aspects, the solid Fluorinated Graphene (GF_{0.8}) electrolyte is energy density enhanced, e.g., by laser induced confined microexplosion from, for example, a solid 100 femtosecond laser.

In aspects, the quantum dot separator is a solid neutralized Graphene a quantum dot separator.

### BRIEF DESCRIPTION OF THE DRAWINGS

Features of this disclosure will become more apparent in view of the following detailed description when taken in conjunction with the accompanying drawings.

FIG. 1 is a diagrammatic representation of a solid-state Graphene battery in accordance with this disclosure; and

FIG. 2 is a flow diagram of a method of preparing a Graphene battery in accordance with this disclosure.

### DETAILED DESCRIPTION

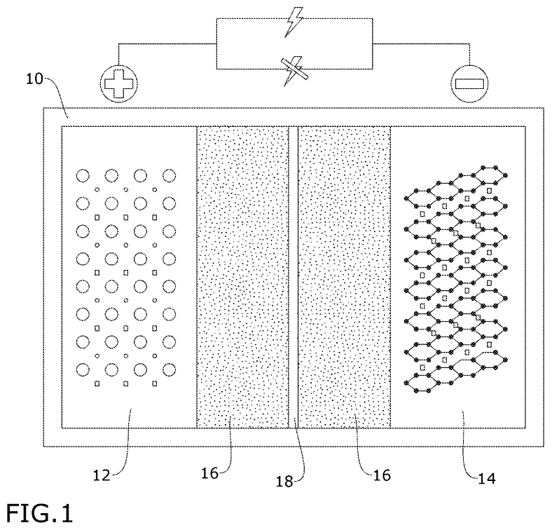

Referring to the FIG. 1, a solid-state Graphene battery provided in accordance with this disclosure is shown including a casing 10, an anode 14, a cathode 12, an electrolyte 16 and, in aspects, a separator 18. Anode 14 and cathode 12 may be positioned at opposite ends of the case 10. The electrolyte 16 may be deposited at the center of the case with the separator 18, in aspects where provided, disposed at the battery's core in the middle of the battery, e.g., in the middle of the electrolyte 16.

Casing 10, in aspects, is a solid layered Graphene casing having, in aspects, at least 100 layers of Graphene. Anode 14 may be a solid negatively charged Graphene Oxide metal, e.g., Nickel-Copper, and may be a nanocomposite, in aspects. Anode 14 can further be energy density enhanced. Cathode 12 may be a solid positively charged Graphene metal, e.g., Nickel-Copper, and may be a nanocomposite, in aspects. Cathode 12 can further be energy density enhanced. Electrolyte 16 is a solid Fluorinated Graphene (GF_{0.8}) and, in aspects, can also be energy density enhanced. Separator 18, in aspects where provided, may be a solid Graphene separator, a solid quantum dot separator and, in aspects, a solid Graphene quantum dot separator.

As noted above, the anode 14 of the Graphene solid state battery of this disclosure may be a solid negatively charged Graphene Oxide metal, e.g., Nickel-Copper, and may be a nanocomposite, in aspects. In aspects, the solid negatively charged Graphene Oxide Nickel-Copper nanocomposite is Graphene Oxide infused with Nickel-Copper as opposed to coated.

A negatively charged Graphene Oxide Nickel-Copper nanocomposite is defined as a formed mass of molecules of the oxidized Carbon allotrope Graphene that has been synthesized with Nickel and Copper compounds, e.g., by ultrasound treatment processing. The Graphene for the negatively charged Graphene Oxide Nickel-Copper nanocomposite must be manufactured. To first synthesize Graphene, Atmospheric Pressure Chemical Vapor Deposition (APCVD) is utilized to directly convert separated Atmospheric Carbon Dioxide with a Copper Palladium alloy film. The APCVD process consists of four steps. With the Carbon Dioxide in direct contact with the Copper Palladium alloy, the substrate is placed in a quartz tube and set in the heat zone of the CVD furnace, which is heated to 1000° C. The substrate is then annealed in the presence of a mixture of Ar and H₂ (1.4:1) for 30 minutes. The growth process is conducted in a mixture of A₂, H2, an₂ CO2 with an 8:5:3.5 ratio at 1000° C. for 40 minutes. The metallic substrate is finally allowed to cool down to room temperature.

With the prepared Graphene, Graphene Oxide is synthesized, e.g., utilizing a simplified Hummers' method without the presence of the KMnO₄ oxidation agent. The original Hummers' method utilizes 100 grams Graphite and an KMnO₄ oxidation agent. The simplified Hummers' method begins with mixing 1 gram of Graphene, 30 milliliters of H₂SO₄ (98%) and 10 milliliters of HNO₃ (98%) in a 1000 milliliters volumetric flask that is stirred continuously for 2 hours. This is followed by the gradual addition of 100 milliliters of water and the ensuing rapid increase of temperature to nearly 100° C. 200 milliliters of water is then added into the solution and it is stirred again. The solution is neutralized with NaOH until a pH 7 is reached. After rinsing with deionized water five times, the mixture is subjected to filtration and oven drying processes.

To synthesize the Graphene Oxide Nickel-Copper nanocomposite, 100 milliliters of ethylene glycol is added to 100 milligrams of Graphene Oxide. The ultrasound process is followed for 1 hour, with 1 milliMole of Copper (II) Nitrate Trihydrate and 1 milliMole of Nickel (II) Nitrate Hexahydrate added into the solution, separately in the beaker. The mixture is treated through ultrasound for another 30 minutes to obtain a homogeneous suspension. Each solution is then transferred into a beaker and the mixture is magnetically agitated at room temperature for 3 hours. Additionally, the pH value is adjusted to about 11 with Ammonia solution. The synthesized Graphene Oxide Nickel-Copper nanocomposite is collected through centrifugation, rinsed with deionized water and Ethanol, correspondingly and dried in a vacuum oven at 60° C. for 12 hours without Hydrazine Hydrate reduction. As can be appreciated, the quantities detailed above and otherwise herein are exemplary and can be scaled up or down keeping the same ratios of materials.

As a final step, a laser system with an approximately 100 femtosecond laser pulse and 100 nanoJoule energy is focused 0.1 nanometers below the surface of the Graphene Oxide Nickel Copper nanocomposite to produce energy density enhancement via laser induced confined microexplosion. This energy density enhancement is accomplished by the laser generating high pressure and high temperature conditions onto the solid surface, thereby increasing the gravimetric energy density of the solid. This energy density enhancement significantly reduces the required weight, mass, and size of the Graphene solid-state battery by increasing its gravimetric and specific energy density by, in aspects, up to 1 kilowatt hour per kilogram.

As noted above, the cathode 12 of the Graphene solid state battery of this disclosure may be a solid positively charged Graphene metal, e.g., Nickel-Copper, and may be a nanocomposite, in aspects. A positively charged Graphene Nickel-Copper nanocomposite is a formed mass of molecules of the Carbon allotrope Graphene that has been synthesized with Nickel and Copper compounds, e.g., by ultrasound treatment processing. The Graphene for the positively charged Graphene Nickel-Copper nanocomposite must be manufactured, which may be accomplished as detailed above with respect to anode 14.

Next, to synthesize the Graphene Nickel-Copper nanocomposite, 100 milliliters of Ethylene Glycol is added to 100 milligrams of Graphene. The ultrasound process, for 1 hour, is followed by 1 mMole of Copper (II) Nitrate Trihydrate and 1 mMole of Nickel (II) Nitrate Hexahydrate added into the solution, separately in the beaker. The mixture is treated through ultrasound for another 30 minutes to obtain a homogeneous suspension. Each solution is then transferred into a beaker and the mixture is magnetically agitated at room temperature for 3 hours. Additionally, the pH value is adjusted to about 11 with Ammonia solution. The synthesized Graphene Nickel Copper nanocomposite is collected through centrifugation, rinsed with deionized water and Ethanol, then dried in a vacuum oven at 60° C. for 12 hours without Hydrazine Hydrate reduction. As noted above, and again as can be appreciated, the quantities detailed above and otherwise herein are exemplary and can be scaled up or down keeping the same ratios of materials.

As a final step, to produce the energy density enhanced Graphene Nickel Copper nanocomposite, a laser system with an approximately 100 femtosecond laser pulse and 100 nanoJoule energy is focused 0.1 nanometers below the surface of the Graphene Nickel Copper nanocomposite to produce laser induced confined microexplosion energy density enhancement, similarly as detailed above.

Graphene Nickel-Copper is known. Graphene Nickel-Copper is leveraged in accordance with this disclosure for use as a positively charged Graphene Nickel-Copper cathode 12 of the solid-state Graphene battery of this disclosure. Oxidation always occurs at the anode 14 and reduction always occurs at the cathode 12. The two electrodes alternate from cathode and anode during the successive discharge and charge processes in the battery. The potential of the redox reactions distinguishes the electrodes as positive (higher potential) and negative (lower potential). Graphene has a significantly higher potential than Graphene Oxide. Accordingly, the designed Graphene Nickel-Copper nanocomposite cathode 12 has an exceptionally higher redox reaction potential than the Graphene Oxide Nickel-Copper nanocomposite anode 14, giving the Graphene Nickel-Copper nanocomposite cathode 12 a positive charge and the Graphene Oxide Nickel-Copper nanocomposite anode a negative charge 14.

The anode 14 of the Graphene solid state battery of this disclosure has heightened electrical conductivity and reduced electric resistance. As detailed above, a negatively charged Graphene Oxide Nickel-Copper anode 14 is utilized to maximize the redox potential difference from the positively charged Graphene Nickel-Copper cathode 12. However, in aspects, it is also contemplated that a reduced Graphene Oxide Nickel-Copper can also be utilized as the anode 14.

Continuing with reference to FIG. 1, the casing 10 of the Graphene solid state battery of this disclosure, in aspects, is a solid layered Graphene casing having, in aspects, at least 100 layers of Graphene. Manufacturing the solid layered Graphene casing 10 may be performed by synthesizing the Graphene layer-by-layer in a prefabricated steel casing mold. To synthesize each layer of Graphene, APCVD is utilized to directly convert separated Atmospheric Carbon Dioxide with a Copper Palladium alloy film. The APCVD process consists of the four steps detailed above. Once all layers have been synthesized, the metallic substrate is finally allowed to cool down to room temperature. Once completely cooled, the Graphene casing is removed from the steel mold and set up for the placement of the battery interior components.

As detailed above, the electrolyte 16 of the Graphene solid-state battery of this disclosure may be a solid Fluorinated Graphene (GF_{0.8}) and, in aspects, can also be energy density enhanced. A Fluorinated Graphene (GF_{0.8}) electrolyte is defined as a solid multilayered (2 or more layers) material. The electrolyte 16 can have a micropore size of 0.6 nm and a semi-ionic C—F bond ratio of 37.7%, in proportion to it 36.3% CF₂ bonds and its 26% covalent C—F bonds. The Fluorinated Graphene (GF_{0.8}) has sp² C content of 22.8%, a CF content of 76% and a CF₂ content of 1.2%. In the Fluorinated Graphene GF_{0.8}, the Carbon content is 48.5%, the Fluorine content is 50% and the Oxygen content is 1.5%.

To produce the Fluorinated Graphene (GF_{0.8}) electrolyte 16, the Graphene for the Fluorinated Graphene (GF_{0.8}) electrolyte 16 must be synthesized, as detailed above.

With the prepared Graphene, Graphene Oxide is synthesized utilizing the simplified Hummers'method as also detailed above. Reduced Graphene Oxide (RGO) is then prepared by thermal reduction for 10 hours under H₂ flow (5 vol. % in Argon) of 20 standard cubic centimeters per minute at 1,000° C. with facile synthesis. The RGO can possess mesopores with ˜4.2 nm pore size without any micropores. The thickness of the RGO can be up to 20 layers. The Brunauer-Emmett-Teller (BET) method specific surface area for the RGO may be 70.2 m² g⁻¹. RGO is heated to 430° C. for 12 hours to generate the Fluorinated Graphene (GF_{0.8}).

As a final step, laser induced confined microexplosion energy density enhancement, as detailed above, is utilized to enhance the energy density of the Fluorinated Graphene (GF_{0.8}). The semi-ionic bond ratio of this resultant GF_{0.8} can provide a gravimetric energy density of up to (or even greater than) 1,073 Wh kg⁻¹.

The Graphene solid-state battery of this disclosure may include, in aspects, a separator 18 such, as, for example, a solid Graphene separator, a solid quantum dot separator and, in aspects, a solid Graphene quantum dot separator, as noted above.

A solid neutralized Graphene quantum dot separator is defined as a solid mass of molecules of the Carbon allotrope Graphene that has been top-down oxidative cleavage processed with concentrated H₂SO₄, HNO₃ & H₂O₂ and pH neutralized by Na₂CO₃ in water, forming functionalized Carboxyl and Hydroxyl groups on the edges of the neutralized Graphene quantum dots. Graphene quantum dots are beneficial for use as battery separators, such as using sulfiphilic and lithiophilic Graphene quantum dots. The Graphene for the solid neutralized Graphene quantum dot separator must be synthesized. To first synthesize Graphene APCVD is utilized, as detailed above.

Once the Graphene has been synthesized, top-down synthesis of the Graphene quantum dots is performed by acidic treatment with H₂SO₄ and HNO₃ of the Graphene, resulting in Graphene quantum dots with surface-rich Carboxyl groups (—COOH) and Hydroxyl groups (—OH) that make the Graphene quantum dots solution highly acidic. Neutralization of these acidic Carboxyl Hydroxyl groups on the Graphene quantum dots is accomplished by way of redispersing in water with Na₂CO₃ as a neutralizing agent. The top-down oxidative cleavage process begins with the application of concentrated H₂SO₄ and HNO₃ to Graphene wherein 300 milligrams of Graphene are added to a 100 milliliter beaker placed on a hot plate with stirring. Then, 60 milliliters of H₂SO₄ (98%) and 20 milliliters of HNO₃ (68%) are slowly added. Stirring is continued for 20 minutes until the warm mixture cools down to room temperature. The mixture is then kept at an elevated temperature for 25 hours for the oxidative cleavage to take place. Four process temperatures, 125° C., 150° C., 175° C., and 200° C., are tested. The amount of Graphene quantum dots increase as the temperature increases. After the Graphene quantum dots are formed, the reaction mixture in each case is cooled down to room temperature, purified by centrifuging at 6000 revolutions per minute for 5 minutes and filtrated using a 0.02 micrometer filter. For the oxidation process of the Graphene quantum dots, 30% H₂O₂ is added to the four groups of Graphene quantum dot solutions. The reaction is carried out under two distinct thermal budgets, 25° C. per 30 minute (RT), and 100° C. per 24 hours (HT). The resulting solutions are again centrifuged at 6000 revolutions per minute for 5 minutes and filtrated using a 0.02 micrometer filter. The filtered synthesized Graphene quantum dots are then redispersed in water with Na₂CO₃ as a neutralizing agent and dialyzed overnight using a dialysis tube (molecular weight cut-off 2000 Da) resulting in Graphene quantum dot solutions with pH close to 7. Adding H₂O₂ in a strong acidic condition (pH ˜1) causes-OH reactions resulting in heightened C—O—C epoxy and O═C—O—H carboxyl groups. This step causes a slight redshift in the PL peak center of the Graphene quantum dots solution caused by Carboxyl groups. The addition of Na₂CO₃ in water for the neutralization of Graphene quantum dots heightens their ionic conductivity, making them advantageous for use as a solid-state separator in the Graphene solid-state battery of this disclosure. The end results of the Na₂CO₃ and H₂O₂ and oxidation and Na₂CO₃ neutralization processes in manufacturing are self-assembled solid neutralized Graphene quantum dots. As a final step, laser induced confined microexplosion energy density enhancement, as detailed above, is utilized to enhance the energy density of the Graphene quantum dots.

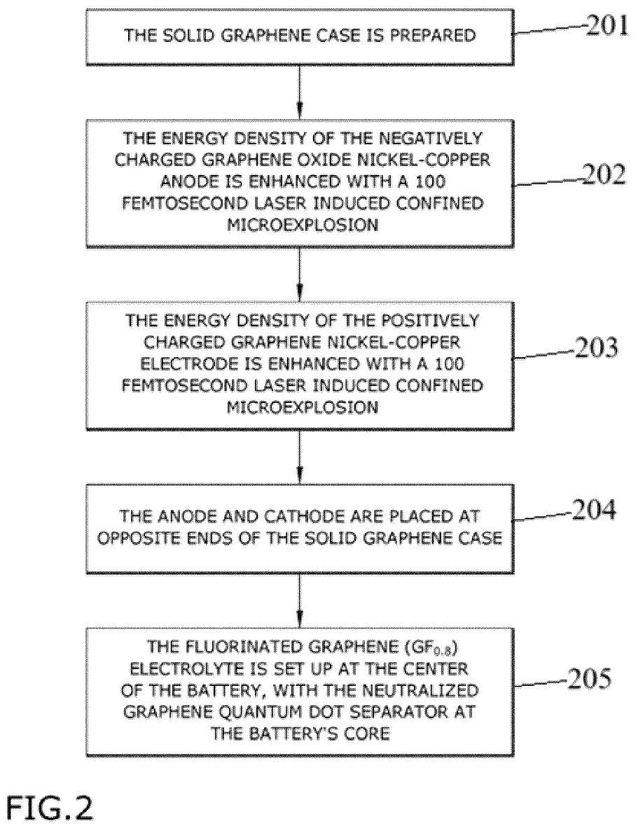

Turning to FIG. 2, as detailed above, the Graphene for the battery may be produced by capturing Carbon Dioxide in the air utilizing Copper Palladium alloys and APCVD in accordance with FIG. 2. This synthesized Graphene may be used to produce the Graphene solid-state battery of this disclosure according to, in aspects, steps 201, 202, 203 and 204 of FIG. 2.

In exemplary applications, the Graphene solid-state battery of this disclosure may be used to power an all-new lineup of ultralightweight Hydrogen internal combustion cars, trucks, SUVs, and passenger buses; all electric powered cars, trucks, SUV's, airplanes, trains, and passenger buses; and/or any other suitable vehicles or for other power generation purposes. The Graphene solid-state battery of this disclosure may also be used to store solar energy in residential homes as well as commercial buildings, generators, and power plants. The battery technology may additionally be used to build ultralightweight Battery Energy Storage Systems (BESS). The Graphene solid-state battery of this disclosure provides a powerful, safe rechargeable battery technology that primarily utilizes and fully incorporates the benefits of Graphene in its multiple solid-state forms and may utilize, in aspects: Graphene generated sustainably from Carbon Dioxide emissions in the atmosphere; a solid-state Fluorinated Graphene (GF_{0.8}) electrolyte; a negatively charged Graphene Oxide Nickel-Copper anode; a positively charged Graphene Nickel-Copper cathode; a Graphene quantum dot separator; and/or a layered Graphene casing. Further, the Graphene solid-state battery, e.g., any or all of the component parts thereof, may be energy density enhanced through femtosecond laser induced confined microexplosion processing.

While several aspects and features of this disclosure are described above and shown in the drawings, it is not intended that this disclosure be limited thereto, as it is intended that the disclosure be as broad in scope as the art will allow and that the specification be read likewise. Therefore, the above description should not be construed as limiting, but merely as exemplifications of particular aspects. Additionally, the aspects and features shown or described in connection with certain configurations can be combined with the aspects and features of certain other configurations without departing from the scope of this disclosure, and such modifications and variations are included within the scope of this disclosure. Accordingly, the subject matter of this disclosure is not limited by what has been particularly shown and/or described.

What is claimed is:

1. A solid-state battery, comprising:
a solid layered Graphene casing;
a solid negatively charged Graphene Oxide Nickel-Copper anode;
a solid positively charged Graphene Nickel-Copper cathode;
a solid Fluorinated Graphene (GF_{0.8}) electrolyte between the solid negatively charged Graphene Oxide Nickel-Copper anode and the solid positively charged Graphene Nickel-Copper cathode; and
a solid Graphene quantum dot separator disposed between the solid negatively charged Graphene Oxide Nickel-Copper anode and the solid positively charged Graphene Nickel-Copper cathode.

2. The solid-state battery according to claim 1, wherein the solid layered Graphene casing includes at least 100 layers of Graphene.

3. The solid-state battery according to claim 1, wherein the solid positively charged Graphene Nickel-Copper cathode is positioned towards one end of the solid layered Graphene casing.

4. The solid-state battery according to claim 3, wherein the solid positively charged Graphene Nickel-Copper cathode is energy density enhanced.

5. The solid-state battery according to claim 1, wherein the solid negatively charged Graphene Oxide Nickel-Copper anode is positioned towards a second end of the solid layered Graphene casing.

6. The solid-state battery according to claim 5, wherein the solid negatively charged Graphene Oxide Nickel-Copper anode is energy density enhanced.

7. The solid-state battery according to claim 1, wherein the solid Fluorinated Graphene (GF_{0.8}) electrolyte is energy density enhanced.

8. The solid-state battery according to claim 1, wherein the solid Graphene quantum dot separator is positioned at the center of the solid Fluorinated Graphene (GF_{0.8}) electrolyte.

9. The solid-state battery according to claim 8, wherein the solid Graphene quantum dot separator is energy density enhanced.

10. The solid-state battery according to claim 9, wherein the solid positively charged Graphene Nickel-Copper cathode is placed towards one end of the solid layered Graphene casing and the solid negatively charged Graphene Oxide Nickel-Copper anode is placed towards an opposite end of the solid layered Graphene casing.

11. A solid-state battery, comprising:
a casing including solid layered Graphene;
an anode including a solid negatively charged Graphene Oxide metal;
a cathode including a solid positively charged Graphene metal; and
an electrolyte including solid Fluorinated Graphene (GF_{0.8}).

12. The solid-state battery according to claim 11, wherein at least one of: the solid negatively charged Graphene Oxide metal is solid negatively charged Graphene Oxide Nickel-Copper or the solid positively charged Graphene metal is solid positively charged Graphene Nickel-Copper.

13. The solid-state battery according to claim 11, wherein the solid negatively charged Graphene Oxide metal is solid negatively charged Graphene Oxide Nickel-Copper and the solid positively charged Graphene metal is solid positively charged Graphene Nickel-Copper.

14. The solid-state battery according to claim 11, further comprising a separator.

15. The solid-state battery according to claim 14, wherein the separator is a quantum dot separator.

16. The solid-state battery according to claim 15, wherein the separator is a solid Graphene quantum dot separator.

17. The solid-state battery according to claim 11, wherein the anode is energy density enhanced.

18. The solid-state battery according to claim 11, wherein the cathode is energy density enhanced.

19. The solid-state battery according to claim 11, wherein the electrolyte is energy density enhanced.

20. The solid-state battery according to claim 11, wherein the separator is energy density enhanced.
